(19) United States
(12) Patent Application Publication
(10) Pub. No.: US 2025/0010447 A1
(43) Pub. Date: Jan. 9, 2025

(54) Multi-Purpose Hand Tool

(71) Applicant: Milwaukee Electric Tool Corporation, Brookfield, WI (US)

(72) Inventors: Jeffrey M. Flynn, Milwaukee, WI (US); Benjamin J. Paprocki, Cottage Grove, WI (US)

(21) Appl. No.: 18/674,002

(22) Filed: May 24, 2024

Related U.S. Application Data
(60) Provisional application No. 63/512,390, filed on Jul. 7, 2023.

(51) Int. Cl. B25F 1/04; B25F 1/00; B25F 5/02

(52) U.S. Cl. CPC B25F 1/04; B25F 1/006; B25F 5/02

(57) ABSTRACT

A multi-tool is shown according to an exemplary embodiment. The multi-tool includes a handle, a reversible shaft removably couplable to the handle, and plurality of tool bits. The plurality of tool bits are removably couplable to a first end and a second of the reversible shaft. In a specific embodiment, at least one of the plurality of tool bits is a punchdown tool bit.

### CROSS-REFERENCE TO RELATED PATENT APPLICATION

The present application claims the benefit of and priority to U.S. Provisional Application No. 63/512,390 filed on Jul. 7, 2023, which is incorporated herein by reference in its entirety.

### BACKGROUND OF THE INVENTION

The present invention relates generally to the field of hand tools. The present invention relates specifically to a hand tool, such as a multipurpose hand tool that is usable with a punchdown tool bit.

### SUMMARY OF THE INVENTION

One embodiment of the invention relates to a hand tool. The hand tool includes a handle with a bore and a tool shaft removably couplable within the bore of the handle. The tool shaft includes a first end having a first recess, a second end opposing the first end and having a second recess, a longitudinal axis extending between the first end and the second end, and a slot defined within the tool shaft adjacent to the first end. The hand tool further includes a biasing component positioned within the slot. The first recess is configured to receive a first reversible tool bit and the second recess is configured to receive a second reversible tool bit. The biasing component is configured to secure the first reversible tool but within the first recess.

Another embodiment of the invention relates to a hand tool. The hand tool includes a handle with a bore and a tool shaft removably couplable within the bore of the handle. The tool shaft includes a first end including a first recess, a second end opposing the first end and including a second recess, and a longitudinal axis extending between the first end and the second end. The hand tool further includes a tool bit holder positioned within the first recess and a spring engaged with the tool bit holder and extending longitudinally along an outer surface of the tool bit holder. The first recess is configured to receive a first reversible tool bit and the second recess is configured to receive a second reversible tool bit.

Another embodiment of the invention relates to a hand tool. The hand tool includes a handle with a bore and a tool shaft removably couplable within the bore of the handle. The tool shaft includes a first end including a first recess, a second end opposing the first end and including a second recess, a longitudinal axis extending between the first end and the second end, and a slot defined within the tool shaft. The slot extends along the longitudinal axis of the tool shaft. The hand tool further includes a spring positioned within the slot. The first recess is configured to receive a first reversible tool bit and the second recess is configured to receive a second reversible tool bit. The biasing component is configured to secure the first reversible tool bit within the first recess.

Additional features and advantages will be set forth in the detailed description which follows, and will be readily apparent to those skilled in the art from the description or recognized by practicing the embodiments as described in the written description and/or shown in the accompany drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments.

### BRIEF DESCRIPTION OF THE DRAWINGS

This application will become more fully understood from the following detailed description, taken in conjunction with the accompanying figures, wherein like reference numerals refer to like elements in which:

FIG. 1 is a perspective view of a multi-purpose hand tool, according to an exemplary embodiment.

FIG. 2 is a cross-sectional view of the multi-purpose hand tool of FIG. 1 taken along line 2-2 of FIG. 1, according to an exemplary embodiment.

FIG. 3 is a top view of the multi-purpose hand tool of FIG. 1 with a portion of the handle removed, according to an exemplary embodiment.

FIG. 4 is a top view of the multi-purpose hand tool of FIG. 1 with the handle removed, according to an exemplary embodiment.

FIG. 5 is a bottom view of the multi-purpose hand tool of FIG. 1 with the handle removed, according to an exemplary embodiment.

FIG. 6 is an exploded view of the multi-purpose hand tool of FIG. 1, with the handle removed, according to an exemplary embodiment.

FIG. 7 is a detailed front perspective view of an end of the multi-purpose hand tool of FIG. 1, according to an exemplary embodiment.

FIG. 8 is a front perspective view from above of the end of the multi-purpose hand tool of FIG. 7, according to an exemplary embodiment.

FIG. 9 is a cross-sectional view of the end of the multi-purpose hand tool of FIG. 7 taken along line 9-9 of FIG. 7, according to an exemplary embodiment.

FIG. 10 is a right side view of a spring of the multi-purpose hand tool of FIG. 1 after being deformed, according to an exemplary embodiment.

FIG. 11 is a perspective view of a punchdown tool bit, according to an exemplary embodiment.

FIG. 12 is a detailed perspective view of an end of a multi-purpose hand tool, according to another exemplary embodiment.

### DETAILED DESCRIPTION

Referring generally to the figures, various embodiments of a hand tool, specifically a multipurpose or multi-tool are shown. Various embodiment of the multi-tool discussed herein include an innovative biasing component for engagement with a tool bit such as a punchdown tool bit. Applicant has determined that it is desirable to maintain a narrow profile for the tool shaft and/or tool bit holder while providing a spring force to secure the punchdown tool bit to the tool shaft and/or tool bit holder. In contrast to conventional methods of securing a tool bit, such as a ball detent and spring that require a substantial wall thickness of the tool shaft to accommodate the securing components, the biasing component discussed herein does not require substantial wall thickness. In various embodiments, the biasing component is a wire form spring. Compared to conventional securing methods, such as use of a c-clamp spring, the wire form spring Applicant has developed has a height that is long compared to a height of the tool shaft. Applicant believes the dimensions and/or shape of the biasing component of the multi-tool discussed herein allows for a secure hold of the punchdown tool bit while maintaining a narrow profile of the tool shaft.

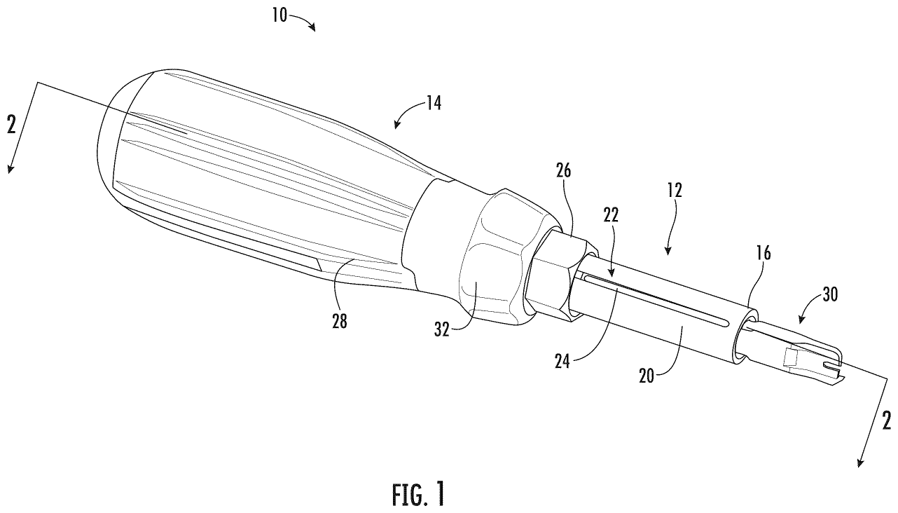

Referring to FIG. 1, a multi-purpose hand tool, shown as a combination punchdown and screwdriver multi-tool is shown, according to an exemplary embodiment. Multi-tool 10 is operable as a punchdown tool to terminate wires at a connector, cross-connect panel, terminal jack, or the like and also operable as a screwdriver to rotate and drive fasteners (e.g., Phillip's head screws, flat head screws, etc.). As will be generally understood, there are various types of punchdown tools (e.g., impact, non-impact). While an impact punchdown tool includes an impact mechanism (i.e., pin ram, hammer spring) to provide a force for cutting, a non-impact punchdown tool may instead include a reversible blade without any impact mechanism.

Multi-tool 10 includes a housing or tool shaft 12 and a handle 14. Handle 14 includes a body 32 and a grip portion 28 that at least partially surrounds the body 32. In various embodiments grip portion 28 includes a plurality of ridges to improve the grip of a user on handle 14. In a specific embodiment, grip portion 28 is formed from a different material than body 32 of handle 14 that provides friction (e.g., rubber, etc.).

A connector 26 is positioned between shaft 12 and handle 14. Connector 26 is shaped to fit within a bore 27 of body 32 of handle 14. Bore 27 will have a shape corresponding to the shape of connector 26. In various embodiments, connector 26 has a polygonal shape. In various specific embodiments, connector 26 has a generally hexagonal shape (i.e., hexagonal prism). The polygonal shape prevents unwanted rotation between connector 26 and handle 14. As will be discussed in greater detail below, connector 26 engages with shaft 12 to inhibit rotation of the shaft 12 relative to the handle 14. As such, when the user rotates the handle 14, the shaft 12 and the tool bit 30 co-rotate with the handle 14.

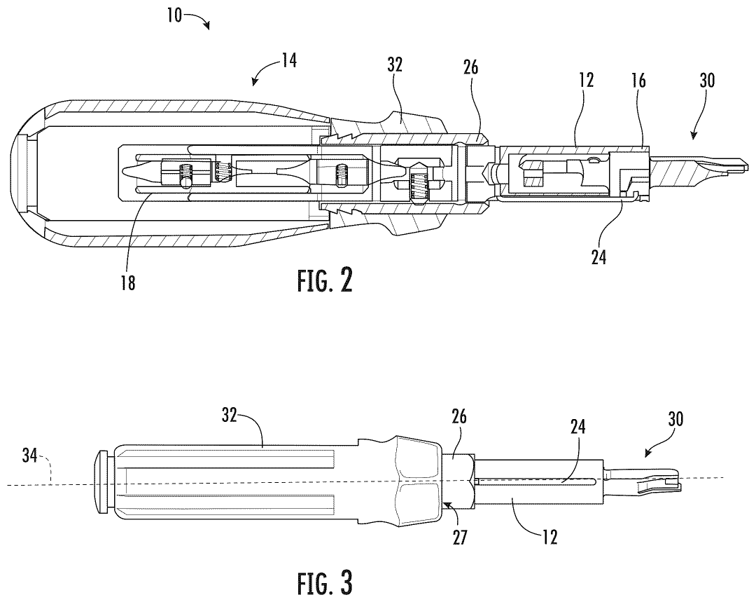

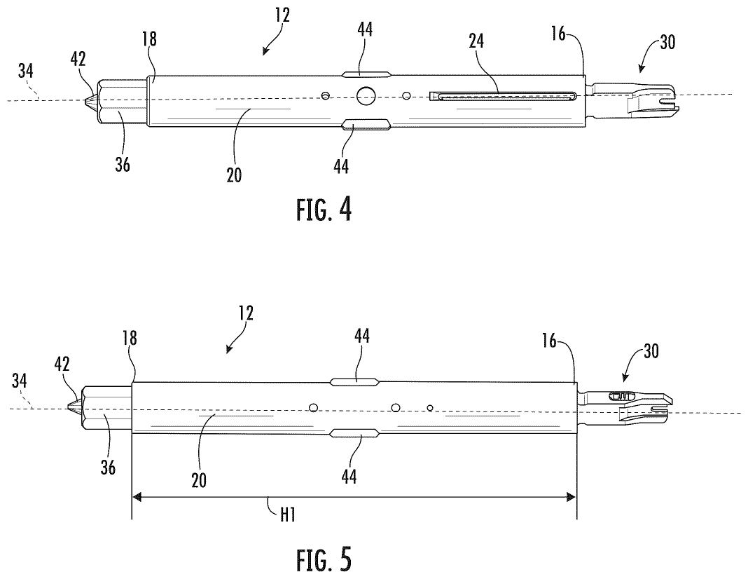

Referring to FIGS. 1-3, shaft 12 includes a first end 16 and a second end 18 (see e.g., FIG. 4) that opposes the first end. The shaft 12 defines a longitudinal axis 34 extending between the first and second ends 16, 18. Shaft 12 includes a generally cylindrical portion 20. A slot 22 is defined within generally cylindrical portion 20 of shaft 12 adjacent to first end 16. Slot extends along longitudinal axis 34 in a generally parallel orientation to longitudinal axis 34. A biasing component, shown as spring 24 is positioned within slot 22. In a specific embodiment, spring 24 is a wire form spring. Multi-tool 10 includes a removable punchdown tool bit 30. Punchdown tool bit 30 extends beyond first end 16 of shaft 12. Punchdown tool bit 30 can include standard configurations such as a 110 or 66 style end. In various embodiments, the punchdown tool bit 30 is reversible and includes, for example, both 110 and 66 style ends. As will be generally understood, the 66 style end is used to connect wires and comes in various sizes (e.g., A, B, and M) and is configured to terminate wires such as 22 through 26 American Wire Gauge (AWG). As will be generally understood, the 110 style end is an updated version of the 66 style end with a different shape and is configured to be used terminate wires such as 22 through 26 American Wire Gauge (AWG).

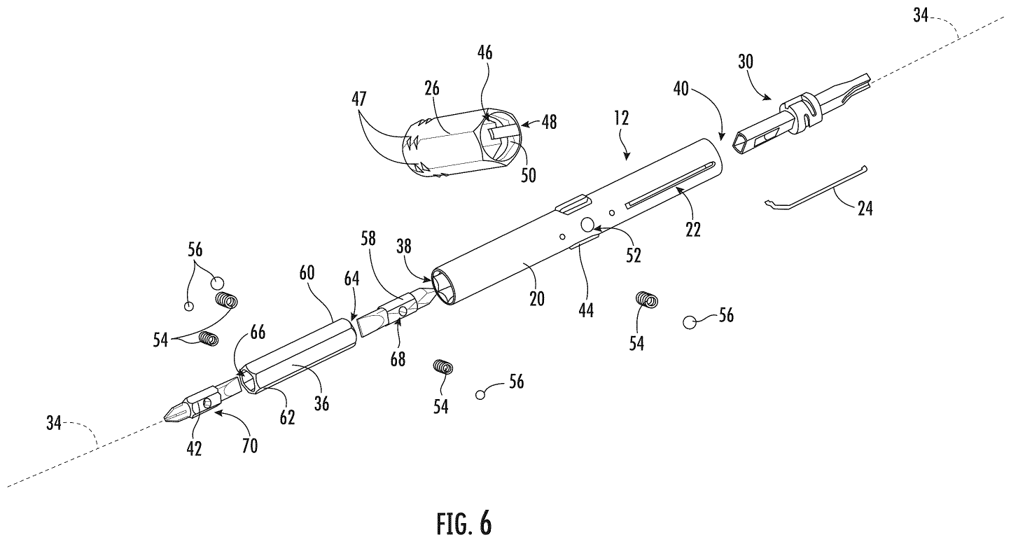

Referring to FIGS. 4-6, a top view, bottom view, and exploded view of multi-tool 10 with handle 14 removed are shown according to an exemplary embodiment. The handle 14 and the shaft 12 are removably coupled so that either the first end 16 or the second end 18 is received within the handle 14. A height H1 of shaft 12 is defined between first end 16 and second end 18 of shaft 12.

First end 16 of shaft 12 includes a first recess 40 configured to receive tool bit 30. At second end 18, shaft 12 includes a second recess 38 configured to receive a tool bit holder 36 and a plurality of tool bits, shown as reversible screwdriver bits 42, 58. Reversible screwdriver bits 42, 58 are removably couplable to tool bit holder 36. Each reversible screwdriver bit 42, 58 includes a bore 70, 68 configured to receive a biasing component, shown as a spring 54 and a ball 56 that together secure bits 42, 58 to tool bit holder 36.

Tool bit holder 36 includes a first end 60 and a second opposing end 64. First end 60 of tool bit holder 36 includes a recess 64 configured to receive reversible tool bit 58. At second end 62 tool bit holder 36 includes a recess 66 configured to receive reversible tool bit 42.

When multi-tool 10 is assembled, shaft 12 is positioned within connector 26. Specifically, connector 26 includes an inner or inward facing surface 50 that defines a channel 46 extending through connector 26. Shaft 12 is positioned within and extends through channel 46 of connector 26 when multi-tool 10 is assembled. Shaft 12 further includes a bore 52 defined in generally cylindrical portion 20 of the shaft 12. Bore 52 extends in a generally perpendicular direction (i.e., 90 degrees plus or minus 10 degrees) to longitudinal axis 34 and is configured to receive spring 54 and a ball 56. When multi-tool 10 is assembled, spring 54 is positioned within bore 52 and provides a force on ball 56. Ball 56 engages inward facing surface 50 of connector 26.

When the second end 18 is received within the handle 14, projections 44 on an outer surface of cylindrical portion 20 engage with corresponding recesses 48 of the connector 26 and shaft 12 is in a first position (see e.g., FIG. 1). Similarly, when the first end 16 is received within the handle 14, the projections 44 engage the recesses 48 of the connector 26 and shaft 12 is in a second position. Engagement between projections 44 and connector 26 together with the engagement between ball 56 and connector 26 resists rotation of shaft 12 relative to connector 26. Thus, the shaft 12 is reversible relative to the handle 14 between the first position and the second position. When the shaft 12 is in the second position, the tool 10 is usable as a screwdriver. When the shaft 12 is in the first position, the tool 10 is usable as a punchdown tool, as described in greater detail below.

The connector 26 further engages with body 32 of handle 14. In various embodiments, an outer surface of connector 26 includes a plurality of ridges 47 configured to engage with body 32 and resist rotation of connector 26 relative to body 32 of handle 14. As such, when the user rotates the handle 14, the shaft 12 and the tool bit 30 co-rotates with the handle 14.

To operate multi-tool 10 as a punchdown tool, the user presses punchdown tool bit 30 onto an exposed wire to terminate the wire. Specifically, tool bit 30 includes an angled or cutting portion to terminate wires. To operate the multi-tool 10 as a screwdriver, the user removes the shaft 12 from the handle 14, then reverses the shaft 12 and inserts the first end 16 into the handle 14. The recesses 48 in the connector 26 receive the projections 44 to inhibit relative rotation between the shaft 12 and the handle 14 during use of multi-tool 10. The reversible screwdriver bits 42, 58 can be used to perform a desired operation on a fastener or other workpiece.

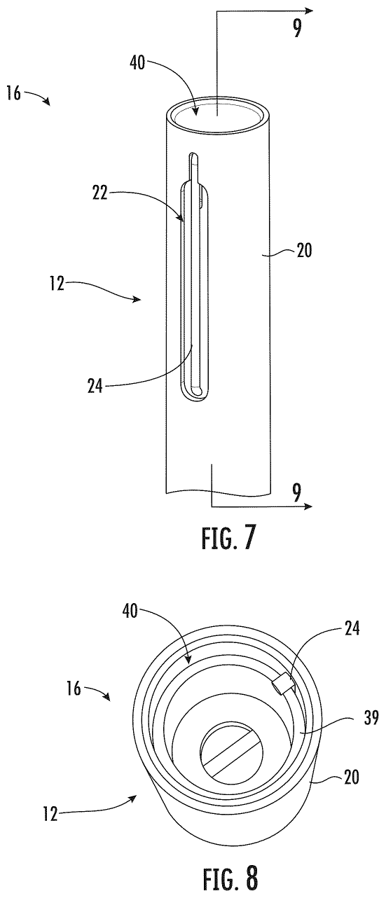

Referring to FIGS. 7-8, details of first end 16 of shaft 12 are shown according to an exemplary embodiment. Spring 24 is positioned within slot 22 defined in generally cylindrical portion 20 of shaft 12 such that spring 24 extends into recess 40. A tool bit holder 39 is positioned within recess 40. In other words, when tool bit holder 39 is positioned within recess 40, a first section of spring 24 extends into a shaft of tool bit holder 39 to secure spring 24 to tool bit holder 39. In a specific embodiment, tool bit holder 39 is integrally formed with shaft 12 and/or recess 40. In other embodiments, bit holder 39 is removably coupled to shaft 12.

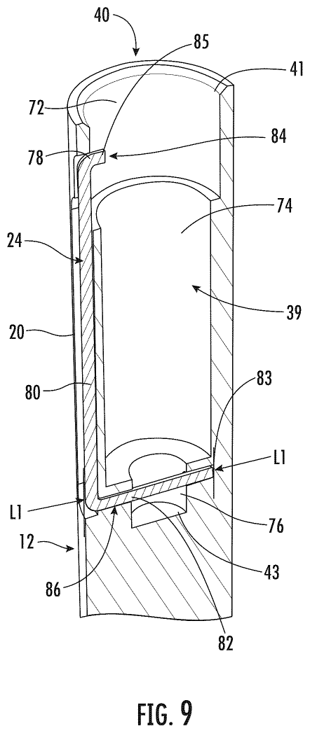

Referring to FIG. 9, a cross-sectional view of first end 16 taken along line 9-9 of FIG. 7, is shown according to an exemplary embodiment. Tool bit holder 39 includes an upper portion, shown as upper cylinder portion 72, a middle portion, shown as middle cylinder portion 74, and a lower portion, shown as lower cylinder portion 76. Middle cylinder portion 74 is positioned between upper cylinder portion 72 and lower cylinder portion 76. Lower cylinder portion is positioned between upper cylinder portion 72 and second end 18 of shaft 12.

Spring 24 includes a first or upper section 78, a generally vertical (in orientation shown in FIG. 9) or longitudinal section 80, and a second or lower section 82. In general, upper section 78 of spring 24 extends into a shaft of tool bit holder 39 near one end of tool bit holder 39 while lower section 82 of spring 24 extends into the shaft of tool bit holder 39 adjacent to the opposing end of tool bit holder 39. Thus, in this arrangement, upper section 78 of spring 24 and a spring end 85 is located between an open end 41 of tool bit holder 39 and lower section 82 in the longitudinal direction (i.e., along longitudinal axis 34 of shaft 12), and lower section 82 is located between the other end 43 of tool bit holder 39 and upper section 78 in the longitudinal direction. Longitudinal section 80 of spring 24 extends along longitudinal axis 34 of shaft 12. Upper section 78 and lower section 82 of spring 24 extend in a generally perpendicular (i.e., 90 degrees plus or minus 10 degrees) direction or orientation from longitudinal section 80 and therefore longitudinal axis 34 of shaft 12.

Upper section 78 of spring 24 extends through the wall of upper cylinder portion 72 and specifically through a bore 84 of upper cylinder portion 72 when multi-tool 10 is assembled. A spring channel 86 extends through first end 16 of shaft 12 and lower cylinder portion 76. In a specific embodiment, spring channel 86 extends through a majority of first end 16 of shaft 12. Lower section 82 of spring 24 is positioned within spring channel 86.

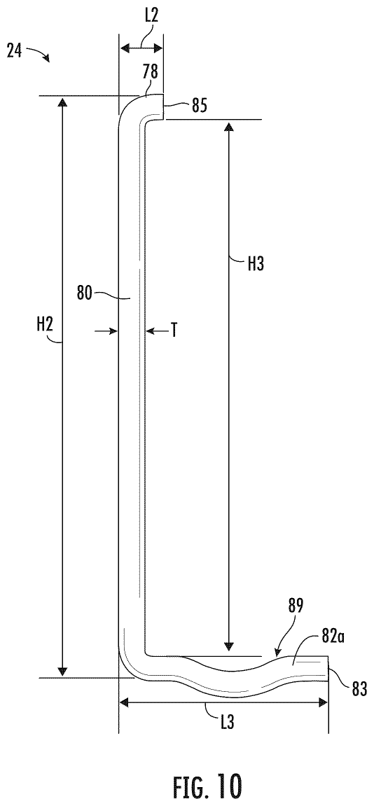

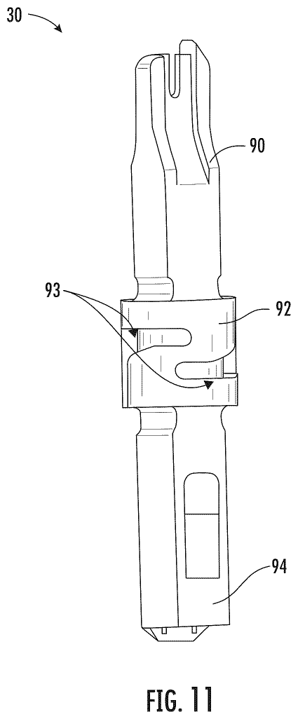

Referring to FIGS. 9-10 details of spring 24 are shown, according to an exemplary embodiment. Lower section 82 of spring 24 includes a first length, L1, defined between an end 83 and longitudinal section 80. In various embodiments, L1 is less than a maximum length.

Spring 24 further includes a thickness T defined between opposing surfaces of longitudinal section 80. In various embodiments, T is between 0.01 inches and 0.07 inches, specifically between 0.02 inches and 0.06 inches, and more specifically between 0.03 inches and 0.05 inches. In a specific embodiment, T is about 0.044 inches (i.e., 0.044 inches plus or minus 0.01 inches).

Longitudinal section 80 of spring 24 has a spring height, H2 defined between an outer surface of lower section 82 and an outer surface of upper section 78 of spring 24. In various embodiments, H2 is between 1 and 1.6 inches, specifically between 1.1 inches and 1.5 inches, and more specifically between 1.2 inches and 1.4 inches. In a specific embodiment, H2 is about 1.38 inches (i.e., 1.38 inches plus or minus 0.05 inches). In various embodiments, L1 is less than 50% of H2.

Longitudinal section 80 of spring 24 has a second spring height, H3 defined between an inner surface of lower section 82 and an inner surface of upper section 78 of spring 24. In various embodiments, H3 is between 80% and 99% of H2, specifically between 85% and 97% of H2, and more specifically between 90% and 95% of H2. In such an embodiment, H3 is about 93% of H1 (i.e., 93% plus or minus 2%).

As previously noted, the height of spring 24 is long relative to the height of shaft 12 compared to conventional securing components. In various embodiments, H2 is greater than 20% of H1. In various embodiments, H2 is between 20% and 40% of H1, specifically between 25% and 35% of H1, and more specifically 29% and 32% of H1. In such an embodiment, H2 is about 31% of H1 (i.e., 31% plus or minus 0.5%).

Upper section 78 of spring 24 includes a second length, L2, defined between an end 85 and longitudinal section 80. In various embodiments, L2 is less than L1. In various specific embodiments L2 is less than 50% of L1. In various embodiments, L2 is less than a maximum length.

After spring 24 is installed in first end 16 of shaft 12 and/or tool bit holder 39, a punch is used to deform spring 24. Specifically, the punch applies a force to lower section 82 of spring 24 to deform lower section 82, securing spring 24 in place. In other words, when the spring 24 is positioned within slot 22, an outer portion or surface of spring 24 is deformed to secure the spring 22 to shaft 12. As shown in FIG. 10, once lower section 82 has been deformed, the deformed lower section 82a does not extend in a fully perpendicular or horizontal orientation from longitudinal section 80. Because of the deformed section 89 of lower section 82a, spring 24 resists removal from tool bit holder 39 spring 24 is securely installed at first end 16 of shaft 12. In other words, deformed section 89 engages spring channel 86 to provide resistance if a user attempts to remove spring 24 from tool bit holder 39.

Deformed lower section 82a of spring 24 includes a third length, L3, defined between the end 83 and longitudinal section 80. In various embodiments, L3 is between 0.1 and 1 inches, specifically between 0.2 and 0.8 inches, and more specifically between 0.4 and 0.6 inches. In a specific embodiment, L3 is about 0.5 inches (i.e., 0.5 inches plus or minus 0.075 inches).

Referring to FIG. 11, details of tool bit 30 are shown according to an exemplary embodiment. In the illustrated embodiment, punchdown tool bit 30 is reversible and includes two ends. First end 90 of punchdown tool bit 30 is a 110 style end, while a second, opposing end 94 is a 66 style end. In various other embodiments, punchdown tool bit may have different end styles. A center body portion 92 is positioned between and connected to first end 90 and second end 94 of punchdown tool bit 30. Center body portion 92 includes a slot 93 configured to engage with upper section 72 of spring 24. In various embodiments, center body portion 92 includes two slots 93 such that punchdown tool bit 30 can be positioned with either side of center body portion 92 facing spring 24.

When spring 24 is installed in tool bit holder 39, upper section 72 of spring extends through the wall of tool bit holder 39 with the spring end 85 freely extending into first recess 40. As punchdown tool bit 30 is positioned within first recess 40, upper section 72 is aligned with and engaged with slot 93. Punchdown tool bit 30 is then rotated within first recess 40 to secure punchdown tool bit 30 relative to shaft 12.

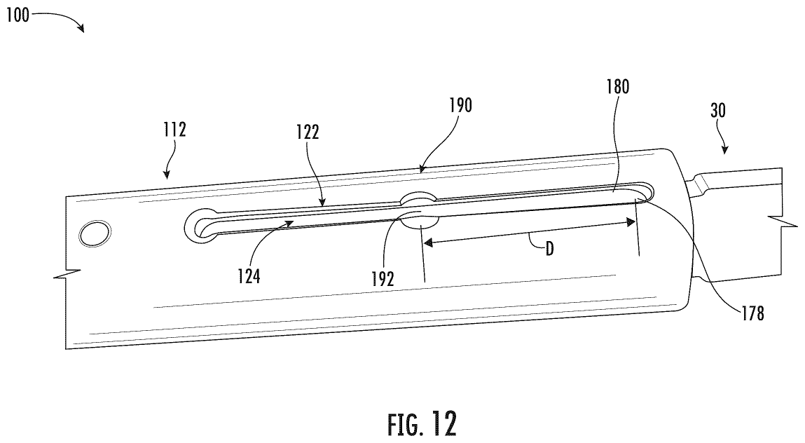

Referring to FIG. 12, a detailed perspective view of a first end 116 of a multi-tool 100 is shown according to another exemplary embodiment. Multi-tool 100 is substantially the same as multi-tool 10 except for the differences discussed herein. Instead of using a punch to secure lower section 82 of spring 24, the punch is used to deform a portion of longitudinal section 180 of spring 124 and shaft 112. Specifically, the punch applies a force to longitudinal section 180 of spring 124 to secure spring 124 in place within slot 122 and relative to shaft 112. A deformed section 190 of spring 124 is positioned along longitudinal section 180 of spring 124

The position (i.e., location where force is applied) of deformed section 190 is chosen to provide a desired spring force for spring 124. The spring force is determined by the cantilever distance D. As will generally be understood, choosing a smaller cantilever distance will provide a larger spring force. Cantilever distance D is defined between an upper section 178 of spring 124 and a center 192 of deformed section 190. In a specific embodiment, D is chosen to be half of the first height of longitudinal section 180. In such an embodiment, the spring force is greater than a minimum force. In other embodiments, D is chosen to be a different distance.

In various specific embodiments, D is between 1% and 99% of H2, specifically between 30% and 80% of H2, and more specifically between 40% and 70% of H2. In such an embodiment D is about 50% of H2 (i.e., 50% plus or minus 5%).

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element, and is not intended to be construed as meaning only one.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature. As used herein, “rigidly coupled” refers to two components being coupled in a manner such that the components move together in a fixed positional relationship when acted upon by a force.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed:

1. A hand tool comprising:
a handle comprising a bore;
a tool shaft removably couplable within the bore of the handle, the tool shaft comprising:
a first end comprising a first recess;
a second end opposing the first end, the second end comprising a second recess;
a longitudinal axis extending between the first end and the second end; and
a slot defined within the tool shaft adjacent to the first end; and
a biasing component positioned within the slot;
wherein the first recess is configured to receive a first reversible tool bit and the second recess is configured to receive a second reversible tool bit, and wherein the biasing component is configured to secure the first reversible tool bit within the first recess.

2. The hand tool of claim 1, wherein the slot extends longitudinally along the longitudinal axis of the tool shaft.

3. The hand tool of claim 1, wherein the biasing component is an elongate biasing component that extends longitudinally along the tool shaft.

4. The hand tool of claim 1, wherein the biasing component is a wire form spring.

5. The hand tool of claim 1, wherein the first reversible tool bit is a punchdown tool bit.

6. The hand tool of claim 5, wherein a first end of the punchdown tool bit is a 110 style end and a second end of the punchdown tool bit is a 66 style end.

7. The hand tool of claim 1, further comprising a tool bit holder positioned within the first recess between the tool shaft and the first reversible tool bit.

8. The hand tool of claim 7, wherein the biasing component comprises a longitudinal section that extends along a longitudinal axis of the tool bit holder.

9. The hand tool of claim 7, wherein the tool bit holder further comprises:
a shaft;
a first end; and
a second end that opposes the first end;
wherein a first biasing component end extends into the shaft of the tool bit holder at the first end, and wherein a second biasing component end extends into the shaft of the tool bit holder at the second end.

10. A hand tool comprising:
a handle comprising a bore;
a tool shaft removably couplable within the bore of the handle, the tool shaft comprising:
a first end comprising a first recess;
a second end opposing the first end, the second end comprising a second recess; and
a longitudinal axis extending between the first end and the second end;
a tool bit holder positioned within the first recess; and
a spring engaged with the tool bit holder and extending longitudinally along an outer surface of the tool bit holder;
wherein the first recess is configured to receive a first reversible tool bit and the second recess is configured to receive a second reversible tool bit.

11. The hand tool of claim 10, the spring further comprising:
a first section;
a second section; and
a longitudinal section extending between and connecting the first section and the second section.

12. The hand tool of claim 11, wherein the first section of the spring and the second section of the spring each extend into a shaft of the tool bit holder to secure the spring to the tool bit holder.

13. The hand tool of claim 10, the tool shaft further comprising a slot extending along the longitudinal axis of the tool shaft.

14. The hand tool of claim 13, wherein the spring is positioned within the slot and an outer portion of the spring is deformed to secure the spring to the tool shaft.

15. A hand tool comprising:
a handle comprising a bore;
a tool shaft removably couplable within the bore of the handle, the tool shaft comprising:
a first end comprising a first recess;
a second end opposing the first end, the second end comprising a second recess;
a longitudinal axis extending between the first end and the second end; and
a slot defined within the tool shaft and extending along the longitudinal axis of the tool shaft;
a spring positioned within the slot;
wherein the first recess is configured to receive a first reversible tool bit and the second recess is configured to receive a second reversible tool bit, and wherein the biasing component is configured to secure the first reversible tool bit within the first recess.

16. The hand tool of claim 15, the spring further comprising:
a first section;
a second section; and
a longitudinal section extending between and connecting the first section and the second section, wherein the longitudinal section is positioned within the slot of the tool shaft.

17. The hand tool of claim 16, wherein a first height is defined between the first section of the spring the second section of the spring, and wherein a second height is defined between the first end and the second end of the tool shaft.

18. The hand tool of claim 17, wherein the first height is greater than 20% of the second height.

19. The hand tool of claim 16, further comprising a tool bit holder positioned within the first recess, wherein the first section of the spring extends into a shaft of the tool bit holder to secure the spring to the tool bit holder.

20. The hand tool of claim 16, wherein the first section of the spring has a generally perpendicular orientation to the longitudinal section of the spring.
